(19) United States
(12) Patent Application Publication
(10) Pub. No.: US 2024/0349232 A1
(43) Pub. Date: Oct. 17, 2024

(54) POWER TOOL WITH ASSOCIATED BEACON

(71) Applicant: Hubbell Incorporated, Shelton, CT (US)

(72) Inventors: Brian McCulloh White, Jr., Manchester, NH (US); Timothy Eugene Willis, Clemson, SC (US); Adam Joseph Clark, Greenville, SC (US)

(21) Appl. No.: 18/292,219

(22) PCT Filed: Jul. 26, 2022
(86) PCT No.: PCT/US2022/038341

§ 371 Date: Jan. 25, 2024

Related U.S. Application Data
(60) Provisional application No. 63/225,625, filed on Jul. 26, 2021.

(51) Int. Cl. H04W 64/00; B25F 5/00; H04W 4/029

(52) U.S. Cl. CPC H04W 64/003; B25F 5/00; H04W 4/029

(57) ABSTRACT

Tool monitoring systems and beacon devices used in the tool monitoring systems are provided. The tool monitoring systems permits one or more beacon devices to upload tool information to a cloud-based computing system either directly or indirectly. Direct communication between the beacon devices and the cloud-based computing system 12 utilizes a communication module and a server. Indirect communication between the beacon devices and the cloud-based computing system utilizes a mobile application running on a mobile computing device or platform and a web services running on the server. The beacon devices are worn by a tool user or installed in a fixed location and communicate with one or more tools to retrieve tool information from the one or more tools and upload the tool information to the cloud-based computing system's database.

### CROSS-REFERENCE TO RELATED APPLICATIONS

The present disclosure is based on and claims benefit from co-pending U.S. Provisional Patent Application Ser. No. 63/225,625 filed on Jul. 26, 2021, entitled “Power Tool with Associated Beacon” the contents of which are incorporated herein in their entirety by reference.

### BACKGROUND

### Field

The present disclosure relates generally to power tool monitoring systems, and more specifically to power tool monitoring systems that include beacon devices that can communicate with power tools and with mobile computing devices and cloud-based computing systems to track power tools.

### Description of the Related Art

Handheld battery powered tools can often be very expensive, including handheld battery powered mechanical and hydraulic crimp and cutting tools that may cost customers several thousand dollars to purchase. These tools are valuable assets, but because they are small enough to be handheld, many customers are concerned about misplacing them, leaving them behind at a work site, or that such tools may be stolen. As a result, the market is seeking a cost effective way to track tools and deter their theft.

One way to track tools is to document all the tools going to a particular work site and assign each tool to the site supervisor. At the end of the job, any tools that are not returned are logged as missing or stolen, and the site supervisor is responsible for lost, missing or stolen tools This places an undue burden on the site supervisor, potentially distracting him/her from the job at hand as they focus their energy on making sure all tools are timely returned. Another way to track tools is to equip the tools with Bluetooth or other wireless communication components so that a smartphone running a mobile application, also known as an App, can log the location of the smartphone when the smartphone was last near the tool. Such methodology for tracking tools has several limitations, including a limited scope of coverage because only specific smartphones may track the location of the tool, and limitations on the use of phones at work sites in that many work sites do not allow any phones on the work site. Another limitation with this methodology for tracking the location of a tool is that the App can only log the smartphone's location, the App does not know the actual location of the tool itself, which may be in a different location or a large distance away from the smartphone.

The present disclosure provides a more reliable and cost effective approach to tracking expensive tools.

### SUMMARY

The present disclosure provides exemplary embodiments of tool management systems and beacon devices used in such tool management systems. In an exemplary embodiment, the tool management system includes one or more beacon devices, one or more tools and a cloud-based computing system. Each of the one or more beacon devices has communication circuitry used for wireless communications. Each of the one or more tools is configured to communicate with the communication circuitry of the one or more beacon devices to up-load system information to the one or more beacon devices. The cloud-based computing system is in wireless communication with the one or more beacon devices and is configured to receive system information from each of the one or more beacon devices and to store the system information in a database. The system information may include tool information, cycle information, a combination of tool information and cycle information and/or any other information about and/or associated with the tool monitoring system and/or the tool and/or its operation.

In another exemplary embodiment, the tool management system includes at least one beacon device and at least one tool. The at least one beacon device has communication circuitry configured for wireless communications. The at least one tool is configured to wirelessly communicate with the communication circuitry of the at least one beacon device, such that when the at least one tool is paired with the at least one beacon device, the at least one tool is configured to upload system information to the paired at least one beacon device. The system information may include tool information, cycle information, a combination of tool information and cycle information and/or any other information about and/or associated with the tool monitoring system and/or the tool and/or its operation. In this exemplary embodiment, the tool monitoring system may also include a cloud-based computing system that is in wireless communication with the at least one beacon device. The cloud-based computing system is configured to receive system information from the at least one beacon device and to store the system information in a database.

In an exemplary embodiment, the beacon device includes a housing, a communication circuit and at least one indicator. The housing has a front housing portion, a rear housing portion and at least one cavity for receiving internal components. The communication circuit is within the at least one cavity of the housing. The communication circuit is configured to receive system information from at least one tool and to upload the system information to a cloud-based computing system. The at least one indicator is used to provide at least an audible, haptic or visual indication when the beacon device is no longer in communication range with the at least one tool. The system information may include tool information, cycle information, a combination of tool information and cycle information and/or any other information about and/or associated with the tool monitoring system and/or the tool and/or its operation.

In another exemplary embodiment, the beacon device includes a housing, communication circuitry and at least one indicator. The housing has a front housing portion, a rear housing portion and at least one cavity for receiving internal components. The housing is preferably configured to be worn by a user, installed in a vehicle or in facility. The communication circuitry is positioned within the at least one cavity of the housing. The communication circuitry is configured to receive system information from at least one tool when the beacon device is in communication range with the at least one tool. The communication circuitry is also configured to upload the system information to a cloud-based computing system when the beacon device is in communication with the cloud-based computing system. The at least one indicator is used to provide at least one of an audible, haptic and visual indication when the beacon device is no longer in communication range with the at least one tool. The system information may include tool information, cycle information, a combination of tool information and cycle information and/or any other information about and/or associated with the tool monitoring system and/or the tool and/or its operation.

In another exemplary embodiment, the beacon device includes a housing, communication circuitry and at least one indicator. Preferably, housing is configured to be worn by a user, installed in a vehicle or in facility. The communication circuitry is positioned within the housing and is configured to receive system information from at least one tool when the beacon device is in communication range with the at least one tool. The at least one indicator is used to provide at least one of an audible, haptic and visual indication when the beacon device is no longer in communication range with the at least one tool. In this exemplary embodiment, the communication circuitry may be configured to upload the system information received from the at least one tool to a cloud-based computing system when the beacon device is in communication with the cloud-based computing system. The system information may include tool information, cycle information, a combination of tool information and cycle information and/or any other information about and/or associated with the tool monitoring system and/or the tool and/or its operation.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a block diagram of an exemplary embodiment of a tool system according to the present disclosure;

FIG. 2 is a front perspective view of an exemplary embodiment of a tool according to the present disclosure;

FIG. 3 is a schematic diagram illustrating an exemplary embodiment of a control system for the tool of FIG. 2;

FIG. 4 is a table illustrating an exemplary embodiment of a data structure for storing cycle information including tool location data during an operating cycle of the tool and time stamp data when the operating cycle of the tool occurred according to the present disclosure;

FIG. 5 is a front perspective view of an exemplary embodiment of a beacon device according to the present disclosure;

FIG. 6 is an elevation view of an exterior of a front cover of the beacon device of FIG. 5;

FIG. 7 is an elevation view of an exterior of a rear cover of the beacon device of FIG. 5, illustrating an exemplary embodiment of a clip secured to the exterior of a rear cover and an exemplary embodiment of an optional lanyard latch that can be releasably connected to the rear cover;

FIG. 8 is a side elevation view of the beacon device of FIG. 7, illustrating the clip separated from the exterior of the rear cover;

FIG. 9 is an elevation view of an interior of the rear cover of the beacon device of FIG. 7 and a printed circuit board that is fitted to the interior of the rear cover;

FIG. 10 is an elevation view of the rear cover of the beacon device of FIG. 9 with the printed circuit board mounted to the interior of the rear cover;

FIG. 11 is a schematic diagram of exemplary power supply circuitry for the beacon device according to the present disclosure;

FIGS. 12A and 12B are a schematic diagram of exemplary indicator generator circuitry for the beacon device according to the present disclosure;

FIGS. 13A and 13B are a schematic diagram of exemplary controller circuitry for the beacon device according to the present disclosure; and

FIG. 14 is a schematic diagram of exemplary accelerometer circuitry for the beacon device according to the present disclosure.

### DETAILED DESCRIPTION

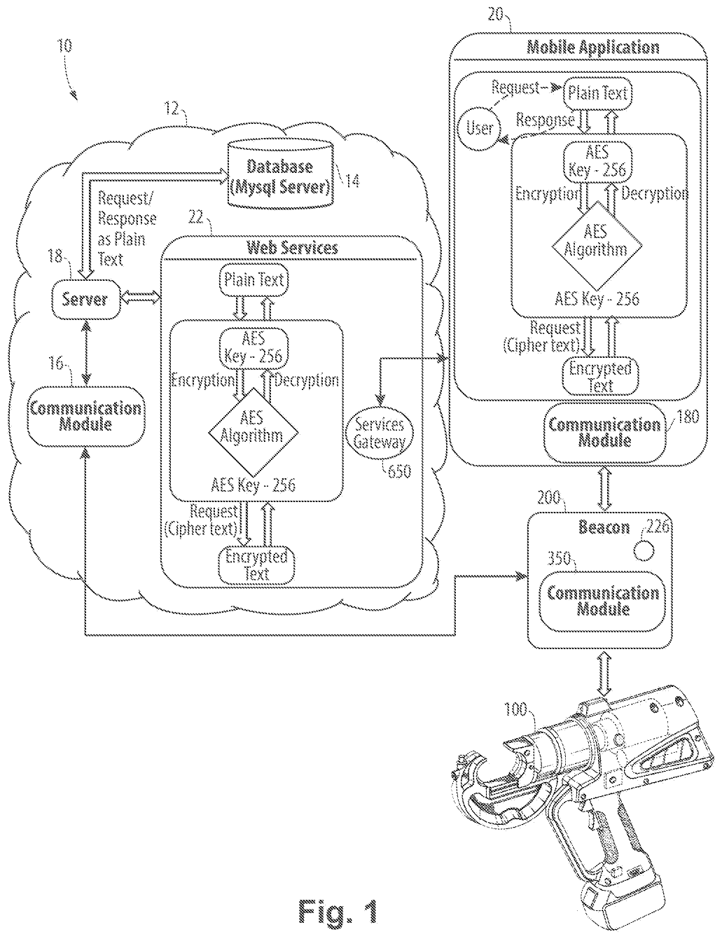

The present disclosure provides embodiments of tool monitoring systems 10 and beacon devices 200 used in the tool monitoring systems as described herein. For ease of description, the tool monitoring systems 10 may also be referred to herein as the “tool systems” in the plural and the “tool system” in the singular. An exemplary embodiment of a tool system 10 is shown in FIG. 1. In this embodiment, the tool systems 10 permits one or more beacon devices 200 to upload system information to a cloud-based computing system 12 with centralized database 14 either directly or indirectly. Direct communication between the beacon devices 200 and the cloud-based computing system 12 having a centralized database 14 utilizes a communication modules 16 and 350. Indirect communication between the beacon devices 200 and the cloud-based computing system 12 utilizes a mobile application, also known as an App, running on a mobile computing device 20, such as a smartphone, and a web services 22 running on the server 18. Web services 22 include encryption/decryption software or hardware that convert plain text into encrypted text or encrypted text into plain text that is transmitted and/or received from mobile application 20 via gateway 650. Mobile application 20 include encryption/decryption software or hardware that convert plain text into encrypted text or encrypted text into plain text that is transmitted and/or received by web services 22 via gateway 650.

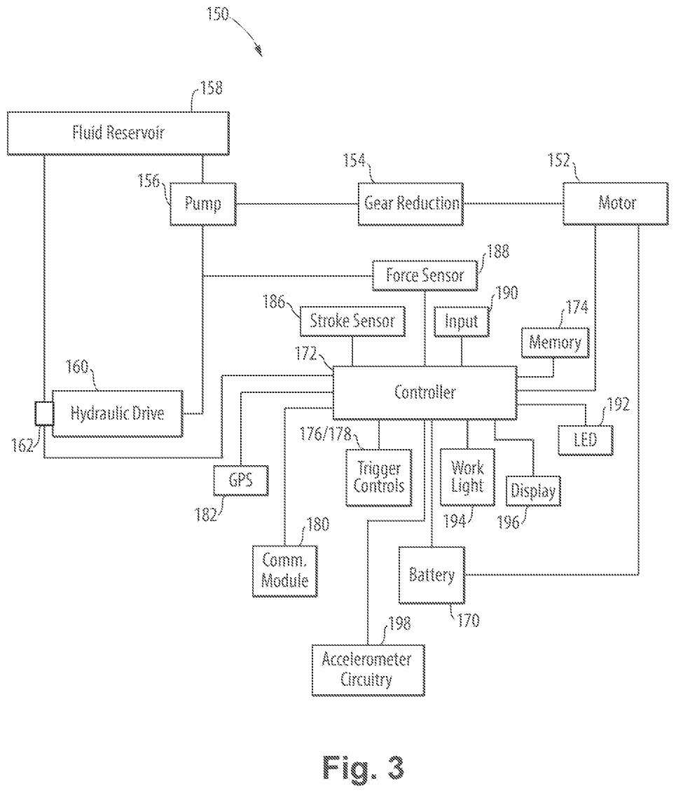

The one or more beacon devices 200 may be worn by tool users, installed in utility trucks and/or a facility, such as a tool crib used to store a plurality tools 100. The tools 100 contemplated by the present disclosure include portable, handheld battery powered mechanical tools and portable, handheld battery powered hydraulic tools. Non-limiting examples of portable, handheld battery powered mechanical tools include drills, impact drivers, and small terminal crimpers. Non-limiting examples of portable, handheld battery powered hydraulic tools include tools configured to apply force in a range or between about 6 tons and about 15 tons. Portable, handheld battery powered hydraulic tools contemplated by the present disclosure include crimping and cutting tools. For ease of description, the tool 100 described briefly herein is a portable, handheld, battery powered, hydraulic crimping tool used to form crimps and other electrical connections on workpieces. The tool 100 described herein also includes systems and circuitry for determining information about and/or associated with the tool and/or its operation, geographical location of the tool 100, and for monitoring and recording cycle information associated with crimp operating cycles of the tool 100. For ease of description, the information about and/or associated with the tool and/or its operation may also be referred to herein as “system information,” the information about and/or associated with the tools 100 contemplated herein may also be referred to herein as “tool information,” and the information about or associated with operating cycles of the tools 100 may also be referred to as the “cycle information.” Thus, system information may include tool information, cycle information, a combination of tool information and cycle information, and/or any other information associated with the tool monitoring system, such as images associated with an operating cycle of the tool. Tool information may include information about and/or associated with the tool 100. As a non-limiting example, tool information may include information about a geographical location of the tool 100. Cycle information may include information about and/or associated with operating cycles of the tool 100. As a non-limiting example, cycle information for a crimping tool may include, but is not limited to, the type and size of the workpiece to be crimped, a force applied by the tool 100 to form the crimp, a time stamp when the crimp was formed, a location of the tool 100 when the crimp was formed that establishes the location of the crimp, status of the crimp, and alpha-numeric information associated with the crimp. Tool information is stored in memory 174, seen in FIG. 3, of the tool 100. Cycle information for a particular crimp is stored in a cycle data record in memory 174 of the tool 100. Each cycle data record may also include other system information, such as images associated with particular crimps. The time stamps contemplated by the present disclosure include, but are not limited to, the time of day a crimp was formed and the date a crimp was formed.

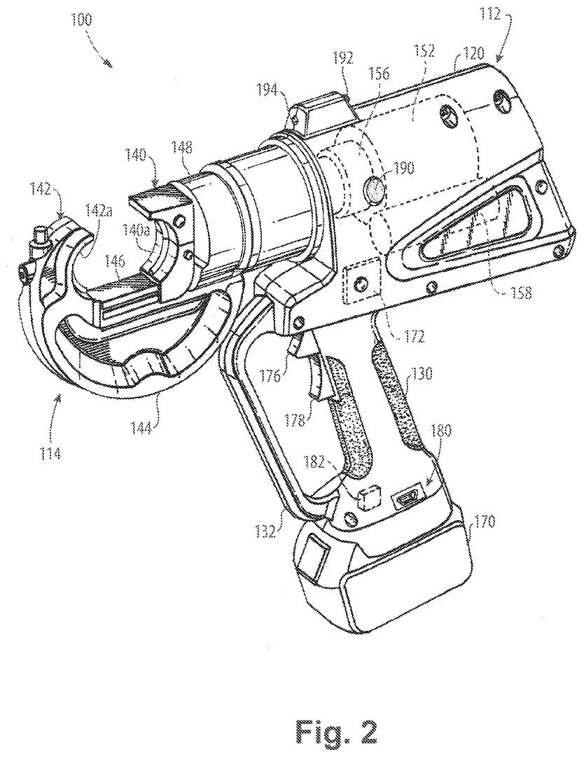

Turning to FIGS. 2 and 3 show an exemplary embodiment of a hydraulic power tool 100. The tool 100 includes a tool frame 112 and a working head 114. The tool frame 112 includes a main body 120 and a handle 130 that form a pistol-like shape. However, the tool frame 112 could be in any suitable type of shape. Within the main body 120 of the tool frame 112 is a battery driven tool control system 150 illustrated schematically in FIG. 3. The tool control system 150 includes a drive system and a control system. In the exemplary embodiment shown, the drive system is a hydraulic drive system that includes a motor 152, a gear reduction box 154, a pump 156, a hydraulic fluid reservoir 158, a hydraulic drive 160 and an optional relief valve 162. However, the drive system may be an electro-mechanical system with the motor 152 and gear reduction box 154. In the exemplary embodiment shown, the control system includes a battery 170, a controller 172, the memory 174, one or more operator controls 176 and 178, a communication module 180, a location sensor 182, e.g., a global positioning system (GPS), a stroke sensor 186, a force sensor 188, an input device 190, one or more status indicators 192, e.g., one or more LEDs, a work light 194, a display 196 and accelerometer circuitry 198.

The battery 170 provides power to the controller 172. The battery 170 also provides power to the motor 152 under the control of controller 172 and the operator controls 176 and 178. The motor 152 drives the pump 156 via gear reduction box 154. The pump 156 is in fluid communication with the hydraulic fluid reservoir 158. When driven by the motor 152, the pump 156 delivers fluid under pressure from reservoir 158 to the hydraulic drive 160. Force generated by hydraulic drive 160 is delivered via a drive arm (not shown), such as a piston within the frame 112, to the working head 114. The force sensor 188 is provided to measure the force applied to a workpiece. Non-limiting examples of the force sensor 188 include pressure sensors or transducers, load cells, strain gauges and other force measuring devices. In the exemplary embodiment of the tool 100 described herein, the force sensor 188 is a pressure sensor. The pressure sensor 188 is connected to the hydraulic drive 160 and senses the hydraulic pressure in the hydraulic drive 160. The controller 172 receives data indicating the pressure in the hydraulic drive 160 from the pressure sensor 188 and determines (or computes) a force applied by the tool 100 on the workpiece. The controller 172 receives signals from the one or more operator trigger controls 176, 178 to activate and deactivate the motor 152 which activates and deactivates the hydraulic drive 160. When the controller 172 activates the motor 152, a work light 194 positioned on the main body 120 of the tool frame 112 may also be activated to illuminate an area of the working head 114 during an operating cycle of the tool 100, here during a crimp cycle.

Continuing to refer to FIG. 3, the relief valve 162 connects the hydraulic drive 160 with the fluid reservoir 158. According to one embodiment, the relief valve 162 is a mechanically actuated valve designed to open when a predetermined maximum pressure is reached in the tool control system 150. When the relief valve 162 is opened, fluid flows from the hydraulic drive 160 back to reservoir 158 relieving pressure in hydraulic drive 160 and removing the force applied on the workpiece by the drive arm (not shown). A spring (not shown) may be provided as part of hydraulic drive 160 to return the drive arm, e.g., a piston within the frame 112, to a home position, shown in FIG. 2, when pressure in hydraulic drive 160 is relieved. It is noted that when the relief valve 162 opens, the relief valve 162 may make an audible indication, such as a “pop” like sound, that the relief valve 162 has opened.

The controller 172 monitors the pressure in hydraulic drive 160 to determine when a crimp cycle is complete. After actuating the motor 152 in response to activation of an operator control, e.g., trigger switch 178, the controller 172 monitors the hydraulic fluid pressure in the hydraulic drive system via the force sensor 188. In embodiments where the optional relief valve 162 is included, when the relief valve 162 opens and the pressure in the hydraulic drive system drops below a predetermined minimum threshold, the controller 172 determines that a crimp cycle is complete. In embodiments where the relief valve 162 is not included, the controller 172 monitors the pressure via the force sensor 188 and when the pressure in the hydraulic drive system reaches a predetermined threshold, e.g., about 5,000 psi or about 11,000 psi, the controller 172 determines that sufficient pressure has been applied to the workpiece such that the operating cycle, here a crimp cycle, is complete. As shown in FIG. 2, an indicator light 192 is positioned on a top portion of the main body 120 of the tool frame 112 facing in the proximal direction so that it is visible to the tool user. The indicator light 192 is electrically connected to the controller 172. According to one embodiment, the light 192 is a bi-color LED that can be energized to illuminate in two distinct colors, such as red and green. However, other types of LED indicators may be used, such as a tri-colored LED capable of emitting red, green and yellow light. When the controller 172 determines that the crimp cycle is complete and that the hydraulic drive system has reached a predetermined threshold pressure, the controller 172 energizes light 192 to illuminate green to indicate a successful crimp. If the hydraulic drive system was not able to reach the predetermined threshold pressure during the crimp cycle, because, for example, there was insufficient battery power to reach the desired threshold pressure or because the pressure setting of the relief valve 162 is out of calibration, the controller 172 energizes the light 192 to illuminate red. It is noted that the present disclosure also contemplates that the controller 172 may activate a sound generating device (not shown) when the controller 172 determines that the crimp cycle is complete, and that the hydraulic drive system has reached a predetermined threshold pressure to indicate a successful crimp.

Referring again to FIGS. 2 and 3, in this exemplary embodiment, the input device 190 is electrically connected to the controller 172 and can be used to initiate or perform a number of different operations. The input device 190 may be, for example, a pushbutton switch. Non-limiting examples of the operations that may be initiated or performed by the input device 190 include pairing the tool 100 to a beacon device 200 and storing system information the memory 174. The input device 190 may be provided on the main body 120 or the handle 130 of the tool frame 112 so that a tool user can easily activate the input device 190.

Also electrically connected to controller 172 is a location sensor 182. The location sensor 182 may be a device to determine the location of the tool 100 based on radio frequency signals received from a global navigation system. Non limiting examples of global navigation systems include the global navigation satellite system (GNSS), the Global Positioning System (GPS), or the Next Generation Operational Control System (OCX) operated by the United States government, the Global Navigation Satellite System (GLONASS) operated by the Russian government, the BeiDou Navigation Satellite System (BNS) operated by the Chinese government, the Quasi-Zenith Satellite System (QZSS) operated by the Japanese government, the Galileo Positioning System operated by the European Union, the India Regional Navigation Satellite System (NAVIC) or the like. As an example, if the global navigation system is the GNSS, the location sensor 182 would be a GNSS antenna module, such as the SAM-M8Q module manufactured by Ublox. The location sensor 182 may be located near the surface of the handle 130 of the tool frame 112, as shown in FIG. 2, to ensure that it can receive radio frequency signals from GNSS satellites. In another exemplary embodiment, the location sensor 182 may be located near the surface of the main body 120 of the tool frame 112. The location sensor 182 may also include other means for determining a location of the tool 100, such as a receiver capable of determining location information from radio frequency sources other than global navigation systems, including cellular phone network transmissions.

The controller 172 may be a microprocessor, microcontroller, application specific integrated circuit, field programmable gate array (FPGA) or other digital processing apparatus as will be appreciated by those skilled in the relevant art. The controller 172 communicates with memory 174 to receive program instructions and to retrieve data. Memory 174 may be read-only memory (ROM), random access memory (RAM), flash memory, and/or other types of electronic storage know to those of skill in the art. The memory 174 may be integrated into controller 172, i.e., in a single IC or module. The controller 172 is also configured to communicate with one or more beacon devices 200 via a communication module 180, seen in FIG. 2. The communication module 180 may be a wireless communication interface, such as Wi-Fi communication interface, a Bluetooth communication interface, and like communication interfaces. In other embodiments, the communication module 180 may be a physical connection, such as a USB port. In other embodiments, the communication module 180 may be a removeable memory device, such as a SIM card, flash drive or combinations thereof.

Continuing to refer to FIGS. 1 and 2, the battery 170 is removably connected to the bottom of the handle 130. In another embodiment, the battery 170 could be removably mounted or connected to any suitable position on the tool frame 112. In another embodiment, the battery 170 may be affixed to the tool 100 so that it is not removable. The battery 170 is preferably a rechargeable battery, such as a lithium ion battery, that can output a sufficient voltage for the tool 100 to perform is operating cycle. For example, the battery 170 may be a rechargeable battery of at least 16 VDC.

The handle 130 also supports the one or more operator controls, such as the trigger switches 176 and 178, that can be manually activated by a tool user. The handle 130 may include a hand guard 132 to protect a tool user's hand while operating the tool 100 and to prevent unintended operation of trigger switches 176 and 178. According to an embodiment of the present disclosure, one of the operator controls (e.g., trigger switch 178) may be used to activate the hydraulic and control system 150 while the other operator control (e.g., trigger switch 176) may be used to cause the hydraulic and control system 150 to deactivate so that the hydraulic drive 160 is depressurized.

Referring again to FIGS. 2 and 3, the working head 114 of the tool 100 may include an impactor 140, and anvil 142, an arm 144 and a guide 146. The impactor 140 has a working surface 140a and is configured to move between a home position, shown in FIG. 2, and a crimping position in which the impactor 140 is acting on the workpiece (not shown). The impactor 140 is configured and dimensioned to connect to or couple with the drive arm (not shown) of the hydraulic and control system 150 within the main body 120 of the tool frame 112. The drive arm may be, for example, a piston. As described above, in an exemplary embodiment, one of the trigger switches (e.g., trigger switch 178) may be used to activate the hydraulic and control system 150 by activating the motor 152 that causes the hydraulic pump 156 to activate via the gear reduction box 154 which pressurizes the hydraulic drive 160 to drive the drive arm in a direction toward the anvil 142. Driving the drive arm in the direction of the anvil 142 causes the impactor 140 to move to the crimping position and deliver force to the workpiece, e.g., a lug connector or a splice connector, onto a conductor. The other trigger switch (e.g., trigger switch 176) may be used to cause the hydraulic and control system 150 to deactivate so that the hydraulic drive 160 is depressurized causing the drive arm to retract in the proximal direction to the home position, shown in FIG. 2. As noted above, a spring (not shown) may be provided as part of hydraulic drive 160 to return the drive arm, e.g., the piston, to the home position when pressure in hydraulic drive 160 is relieved. The impactor 140 is operatively coupled to the guide 146 on the arm 144 of the working head 114 so that the impactor 140 can move along the guide 146 as the drive arm moves the impactor 140 between the home and crimping positions. For example, when the drive arm is driven in the direction of the anvil 142, the drive arm moves the impactor 140 along the guide 146 from the home position, seen in FIG. 2, toward the crimping position.

The arm 144 has at its proximal end a ring 148 used to connect the working head 114 to the tool frame 112, as is known. In one exemplary embodiment, the working head 114 and the frame 112 may be permanently joined with one another via the ring 148. The ring 148 has a center aperture (not shown) through which the drive arm passes in order to connect to the impactor 140. The distal end of the arm 144 includes or forms the anvil 142 such that the anvil is fixed in position. The anvil 142 has a working surface 142a. When a workpiece, such as a lug connector or a splice connector, is placed in the working head 114 between the impactor 140 and the anvil 142, and a conductor or conductors are inserted into workpiece, the motor 152 of the tool 100 can be activated so that the drive arm is driven from the home position toward the crimping position. As the impactor 140 moves toward the anvil 142, the workpiece may also move toward the anvil 142. When the impactor 140 and anvil 142 both contact the workpiece further movement of the impactor 140 causes the working surface 140a of the impactor 140 and the working surface 142a of the anvil 142 to deform the workpiece thus making the crimp. It is noted that the home position is when the impactor 140 is adjacent the ring 148 and the crimping position is when the impactor 140 and anvil 142 deform the workpiece.

To measure the force applied by the impactor 140 on the workpiece, the force sensor 188, which in this exemplary embodiment is a pressure sensor, is located in fluid communication with the hydraulic drive 160. When the drive arm drives the impactor 140 distally until the impactor 140 is in the crimping position, the force applied by the impactor 140 onto the workpiece is monitored by the force sensor 188. According to yet another embodiment of the disclosure, the force sensor 188 may be located elsewhere, such as between the impactor 140 and the anvil 142, or between the impactor 140 and a die attached to the impactor 140 or between the anvil 142 and a die attached to the anvil 142 to measure force applied by impactor 140 on the workpiece. According to another embodiment, the force sensor 188 may be a strain gauge mounted on arm 144 and used to measure the force applied to a workpiece.

According to one embodiment, the impactor 140 and anvil 142 may be configured and dimensioned so that when the drive arm pressed the impactor 140 into the anvil 142 the working surface 140a of the impactor 140 and the working surface 142a of the anvil 142 form a crimp connection with the desired shape. According to another embodiment, the impactor 140 and/or anvil 142 may include surface features that allow die, such as die to be releasably connected to the impactor 140 and/or the anvil 142. Each die has a working surface as is known. By using replaceable die, a variety of working surfaces can be provided on the tool 100 to produce a variety of different shaped crimp connections or cutting operations.

According to yet another embodiment, a stroke sensor 186, seen in FIG. 3, may be provided. The stroke sensor 186 determines when the drive arm has reached the end of its range and/or that the working surfaces of the impactor 140 and anvil 142 or die attached to the impactor 140 and anvil 142 are at their closest approach. When the working surfaces are at their closest approach, the space defined by the working surfaces form the desired shape of the finished crimp connection. The controller 172 monitors the stroke sensor 186 and when the drive arm is at the end of its range, the controller 172 may, if the optional relief valve 162 is included, open the relief valve completing the operation cycle of the tool 100. In embodiments where the relief valve 162 is not included, the controller 172 monitors the stroke sensor 186 and when the drive arm is at the end of its range, the controller 172 turns the motor 118 off completing the operation cycle of the tool 100. The controller 172 may also monitor the force sensor 188, and as with the previous embodiments, the light 192 can be illuminated either green or red, depending on whether a threshold pressure was reached during the operating cycle. In other embodiments, the controller 172 may also monitor the stroke sensor 186 and/or the force sensor 188 to record and store system information for tool cycle quality assurance purposes.

According to a further embodiment, the force sensor 188 may be a load cell that monitors the force applied to the workpiece during the crimp cycle. The force measurement by the force sensor 188, e.g., a load cell, may be used by the controller 172 instead of (or possibly in addition to) the pressure monitored by a force sensor 188, e.g., a pressure sensor, to determine whether sufficient maximum force is applied during an operating cycle of the tool 100. The force sensor 188 may be a load cell that is positioned between the impactor 140 and the anvil 142, or between the impactor 140 and one of the die (not shown) attached to the impactor 140 or between the anvil 142 and one of the die (not shown) attached to the anvil 142.

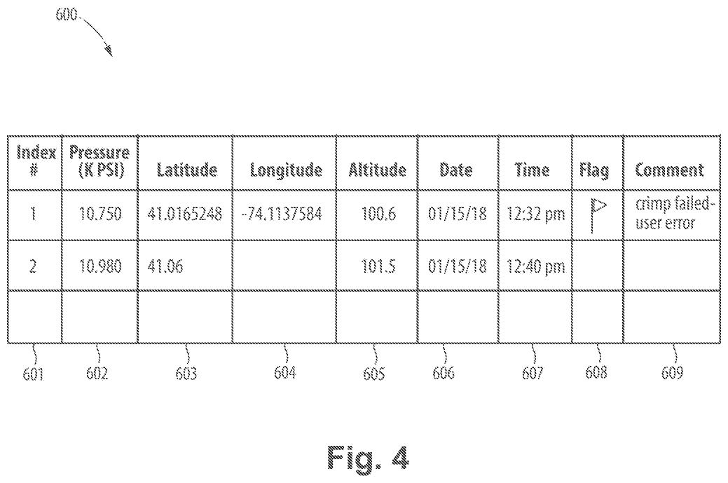

Referring to FIG. 4, an example of cycle data records of system information stored in memory 174 is shown. In the exemplary embodiment shown, the system information generally includes cycle information, but the system information may include tool information and/or other system information. The cycle data records are illustrated here by a table of data arranged in rows, but a variety of data structures known to those with skill in the relevant field could be used. In this embodiment, each row records cycle information for a particular operating cycle, here a crimp cycle, of the tool 100. In the column 601 of the table 600 an index number is stored. According to one embodiment, the index number is indicative of the particular crimp cycle performed by the tool 100 out of the total number of cycles the tool 100 has made and serves to uniquely identify each crimp cycle recorded. The index number may also be used to determine if the tool 100 needs to be recalibrated according to a maintenance schedule. Column 602 records the maximum force, e.g., pressure, applied or a maximum hydraulic pressure achieved by the hydraulic drive 160 during the crimp cycle. Alternatively, instead of recording a maximum force or pressure, a logical value (e.g., “Pass” or “Fail”) indicating that sufficient pressure was or was not achieved during the crimp cycle could be recorded. Columns 603 and 604 record the location of the tool 100 when the crimp is formed, i.e., at the completion of a crimp cycle. According to one embodiment, the tool 100 location is recorded as a latitude and longitude. According to a further embodiment, the altitude of the tool 100 may be recorded in column 605 so that if the tool 100 is used on a floor of a building, the floor of the building where the crimp was made can be determined by the altitude. Columns 606 and 607 record the time stamp associated with when the crimp cycle was completed or activated. In the exemplary embodiment of FIG. 4, the time stamp includes the time and date when the crimp cycle was activated. In another embodiment, the timestamp may be represented by a single value, e.g., in Unix Time. Column 608 holds a flag that may have been added to the data record by activating the input device 190, seen in FIG. 2, following a crimp cycle. In the embodiment illustrated in FIG. 4, the first cycle data record includes a flag. For each subsequent cycle of the tool 100, a new cycle data record of cycle information is added to memory 174, as illustrated by a new row of the table. Column 609 holds alpha-numeric comments that may have been added to the data record by the tool user, such as “crimped failed due to user error.” The present application also contemplates that the comments may include crimp location information or other information that may confirm or help with the location of crimps formed by a particular tool. In another embodiment, other information related to the crimp operation (cycle information) could be stored, such as stroke measurement or resistance verification.

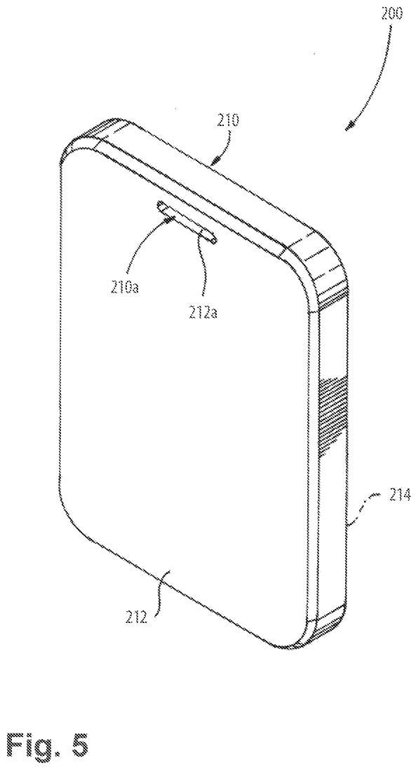

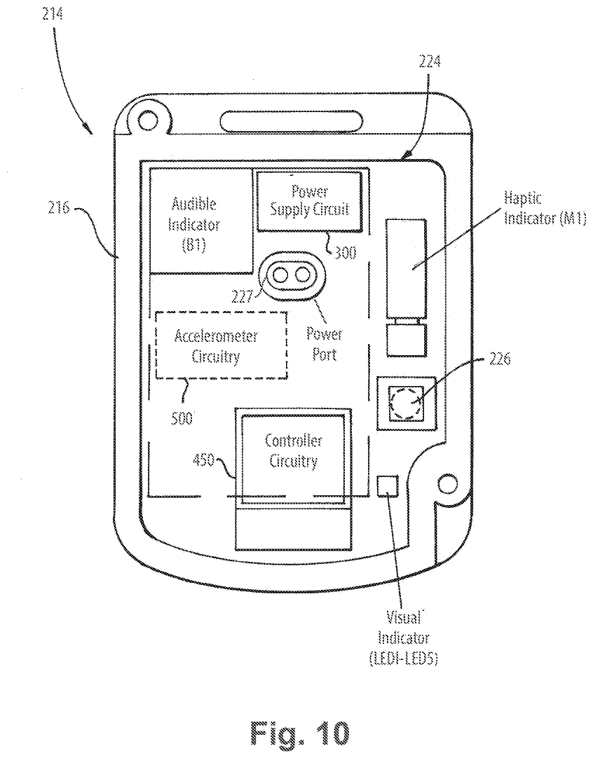

Turning now to FIGS. 5-10, an exemplary embodiment of a beacon device 200 according to the present disclosure is shown. By deploying embodiments of the beacon device 200 contemplated by the present disclosure on tool users, in utility vehicles and/or in a facility, such as a tool crib, the location of one or more tools 100 paired with the beacon device 200 can be determined and automatically recorded without the need to use a smartphone with a particular mobile application (the App) running on the smartphone. More specifically, by pairing one or more beacons 200 with one or more tools 100 equipped with an onboard location sensor 182, e.g., an onboard GPS device, described above, the location of the one or more tools 100 can be transferred to the one or more beacons 200 when the tools 100 upload system information to the one or more beacons 200. As a result, the last known locations of the one or more tools 100 are actually known, as described in more detail below.

Preferably, the beacon device 200 is a small device that can be worn by a tool user, mounted to a utility vehicle or installed at a facility, such as a tool crib. A tool user can wear the beacon 200, using for example a clip or lanyard or key ring. By having a user wear the beacon 200, or having the beacon 200 mounted to a utility vehicle or installed at a facility, the beacon device 200 can be configured to alert the tool user directly or alert personnel within the truck or facility when the beacon device 200 is no longer within communication range with the tool 100. In other words, when the beacon device 200 is no longer receiving a signal from the tool 100. This alert may help prevent the tool 100 from being left behind at a work site or stolen from a work site. The alert may be, for example, an audible alert, a visual alert and/or a haptic alert. Further, if each tool user wears a beacon 200, it may be quicker to determine which tool user was last within communication range of a particular tool 100, which would allow tool managers to easily know which tool user to contact when the tool manager notices that a particular tool 100 was not returned to inventory.

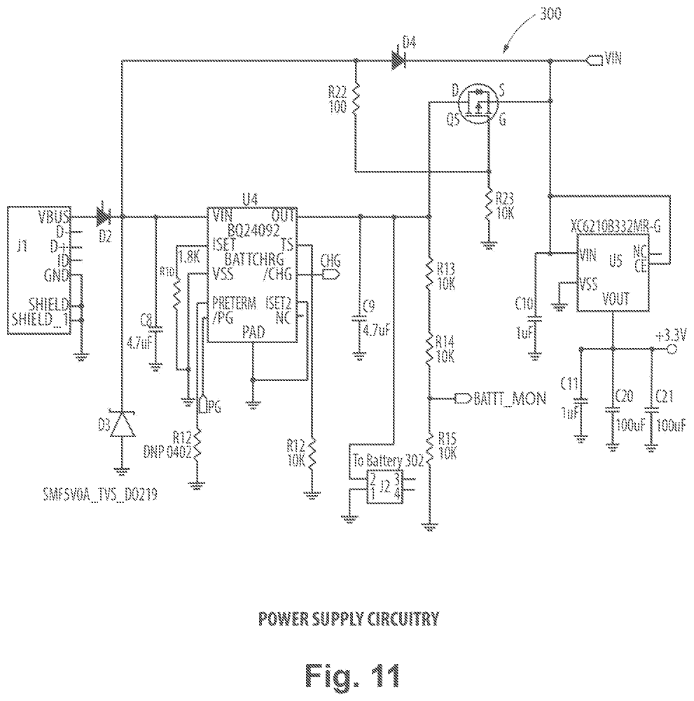

In the exemplary embodiment of FIGS. 5-10, the beacon device 200 includes a housing or casing 210 having a front housing portion 212 and a rear housing portion 214 that may be permanently affixed to the front housing portion 212 or releasably secured to the front housing portion 212 using, for example, fasteners such as screws, or a snap-fit connection. The front housing portion 212 may be sealed to the rear housing portion 214 using one or more seal members 216, seen in FIG. 9. The one or more seal members 216 may be gaskets such as elastomeric, rubber or foam gaskets that limit and possibly prevent moisture or water (rain, laundry cycles, etc.) from entering the housing 210. Within the inside of the front housing portion 212 and/or the inside of the rear housing portion 214 is one or more cavities 218, seen in FIG. 9, used to receive the internal components of the beacon 200. Preferably, the housing 210 is constructed of a lightweight, rigid material. In an exemplary embodiment, the housing 210 may be constructed of a polymer material that may be translucent. In another exemplary embodiment, the housing 210 may be constructed of a polymer material that may be translucent and mixed with antimicrobial additives to form an antimicrobial plastic. An antimicrobial plastic is a synthetic polymer material containing an integrated antimicrobial additive ingredient which makes the polymer material effective against microbial growth. Non-limiting examples of such polymer materials include injection molded or extruded thermoplastic polymers. Non-limiting examples of such polymer materials include Acrylonitrile Butadiene Styrene (ABS), Polypropylene (PP), Polystyrene (PS), Polyethylene (PE/LDPE), Polyvinyl chloride (PVC) and Polycarbonate (PC). Non-limiting examples of antimicrobial additives include non-metallic based antimicrobial additives.

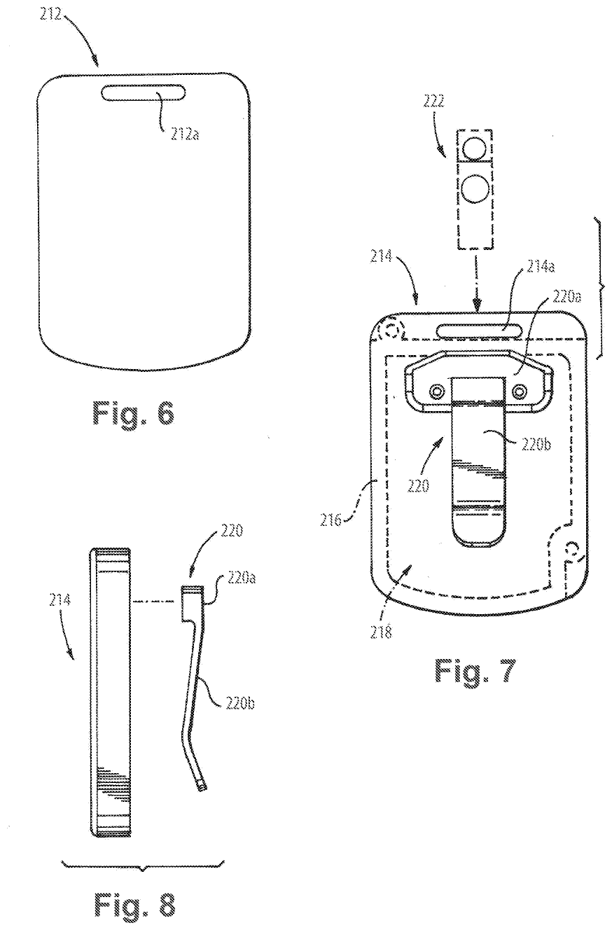

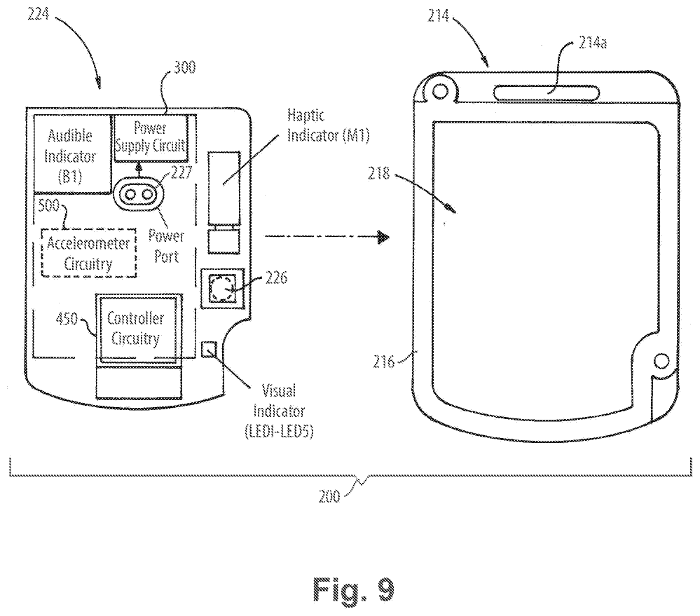

The housing 210 may also include a clip member 220 attached to or monolithically formed into the rear housing portion 214 and used to releasably attach the beacon device 200 to, for example, a belt of a tool user. In the exemplary embodiment shown, the clip member 220 includes a mounting bracket 220a and a clip 220b. In another exemplary embodiment, the housing 210 may include a strap receiving slot 210a, seen in FIG. 5, instead of or in addition to the clip member 220. In this embodiment, the strap receiving slot 210a is formed by a receiving slot 212a in the front housing portion 212, seen in FIG. 6, and a strap receiving slot 214a in the rear housing portion 214, seen in FIG. 7. The strap receiving slot 210a is configured and dimensioned to receive a lanyard latch 222 attached to, for example, a lanyard or strap or key ring (not shown).

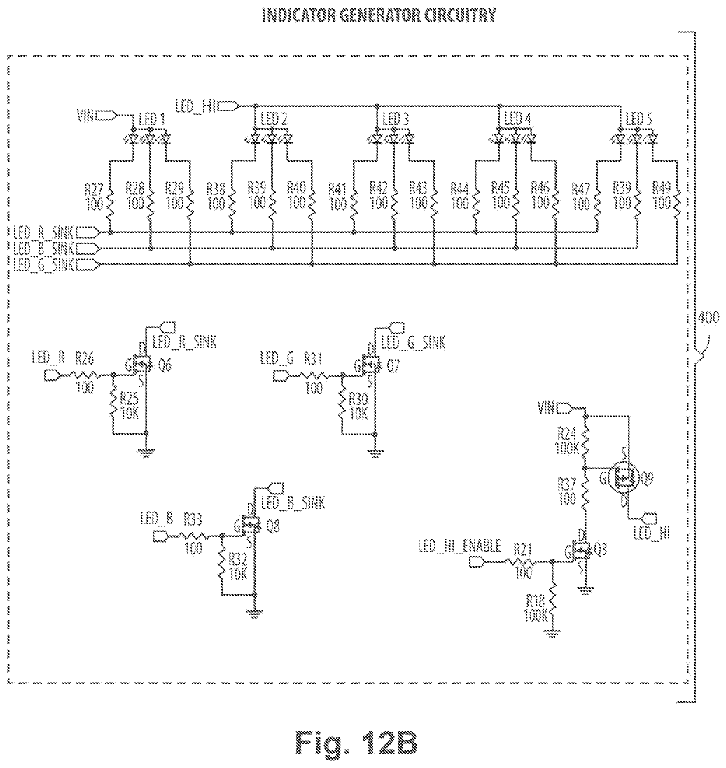

Referring now to FIGS. 9-14, the internal components and circuits of the beacon device 200 are shown. Internal circuitry of the beacon device 200 is mounted on a printed circuit board 224 that may be mounted within a cavity 218 in the front housing portion 212, seen in FIG. 5, or the rear housing portion 214, seen in FIG. 5. In another embodiment, the printed circuit board 224 may be fitted within the cavity 218 so that the printed circuit board 224 is fitted between the front housing portion 212 and the rear housing portion 214. In the exemplary embodiment shown, the internal circuitry of the beacon device 200 includes power supply circuitry 300, a switch 226, a power port 227, a communication module 350, indicator generator circuitry 400 and controller circuitry 450. In the embodiments shown herein, the communication module 350 is part of the controller circuitry 450. However, the present disclosure contemplates that the communication module 350 may be a separate module or separate circuitry that permits the beacon devices 200 to electronically communicate with other tools 100, other beacon devices 200, mobile computing devices 20, seen in FIG. 1, cloud-based computing systems 12 and other devices. The internal circuitry of the beacon device 200 may also include accelerometer circuitry 500 that is controlled by the controller circuitry 450. As shown in FIG. 11, the power supply circuitry 300 includes a battery charging circuit U4 used to charge the battery 302 and a voltage regulator network used to regulate the voltage supplied to the internal circuitry of the beacon device 200. In the exemplary embodiments of the beacon device 200 described herein, the battery 302 is a rechargeable battery that provides power to the internal components of the beacon devices 200. The beacon device's battery 302 may be recharged via a charging station (not shown) which could be secured to a utility vehicle or installed in a facility. Such a charging station could be configured to accept a single beacon device 200 to recharge its internal battery 302, or the charging station could be configured to accept multiple beacon devices 200 to recharge their internal batteries 302.

In another exemplary embodiment, a charging station (not shown) could be equipped with a cellular module and could download the system information, including the locations of each of the one or more tools 100 paired with the one or more beacon devices 200 being charged, to instantaneously update the cloud computing system database 14, seen in FIG. 1, with the locations of all tools 100 paired with the beacon devices 200 being charged. It is noted that pairing a beacon device 200 to a tool 100 or pairing a beacon device 200 to a mobile computing device 20, seen in FIG. 1, or pairing the beacon device 200 to any other device or system is used in the conventional sense where there is a one-time association between the devices and the details of the association are saved for later connections so that when the devices are within a predefined communication distance using for example, Bluetooth, Wi-Fi, cellular or other communication technologies, the devices connect so that the devices can communicate. It is noted that the predefined communication distance is a distance at which one device, e.g., tool 100, receives wireless signals from another device, e.g., beacon device 200, with sufficient signal strength in which to wirelessly communicate with each other.

Once a beacon device 200 is paired to the one or more tools 100, when the beacon device 200 is within the predefined communication distance with one or more tools 100, the beacon device 200 automatically connects to the one or more paired tools 100. When the beacon device 200 is connected to the one or more tools 100, the beacon device 200 regularly receives signals from the one or more tools 100 to obtain their last known location. It is also possible for the beacon device 200 to store other system information, such as cycle information, e.g., tool crimp histories, as the tool 100 is used. In one embodiment, when the beacon device 200 is connected to a paired mobile computing device 20, e.g., a smartphone, the beacon device 200 may upload the latest system information to the mobile computing device 20 which then uploads the latest system information to the cloud computing system 12 and database 14. In another embodiment, if the beacon device 200 is configured to wirelessly access the internet, when the beacon device 200 is within range of, for example a Wi-Fi network, the beacon device 200 can upload the latest system information to the cloud computing system database 14. In another embodiment, the beacon device 200 may include the communication module 350, seen in FIG. 1, that includes a cellular module so that system information for each of the one or more tools 100 paired with the beacon device 200 may be instantaneously uploaded to the cloud computing system 12 and database 14 without the need to connect to a mobile computing device 20, charging station, or a Wi-Fi network.

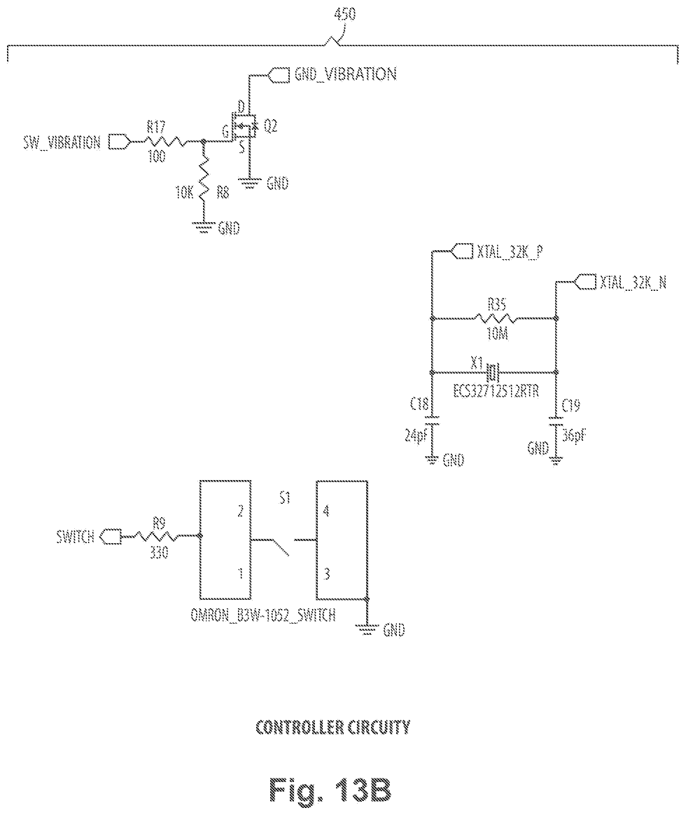

In this embodiment, the communication means is based on Bluetooth and/or Wi-Fi technology and is used for communicating with one or more tools 100, the cloud based computing system 12 centralized data base 14 and/or mobile computing device 20, seen in FIG. 1. However, other wireless communication technologies may be used. For example, the communication means may be a wireless communication interface, such as a Bluetooth communication interface, and like communication interfaces. In the exemplary embodiment shown in FIGS. 13A and 13B, the controller circuitry 450 includes an ESP32 module that contains both BLE and Wi-Fi 802.11 standard radios forming at least a portion of the communication module 350. As noted above, the communication module 350 may also include a cellular module or circuitry so that system information for each of the one or more tools 100 paired with the beacon device 200 may be instantaneously uploaded to the cloud computing system 12 and database 14.

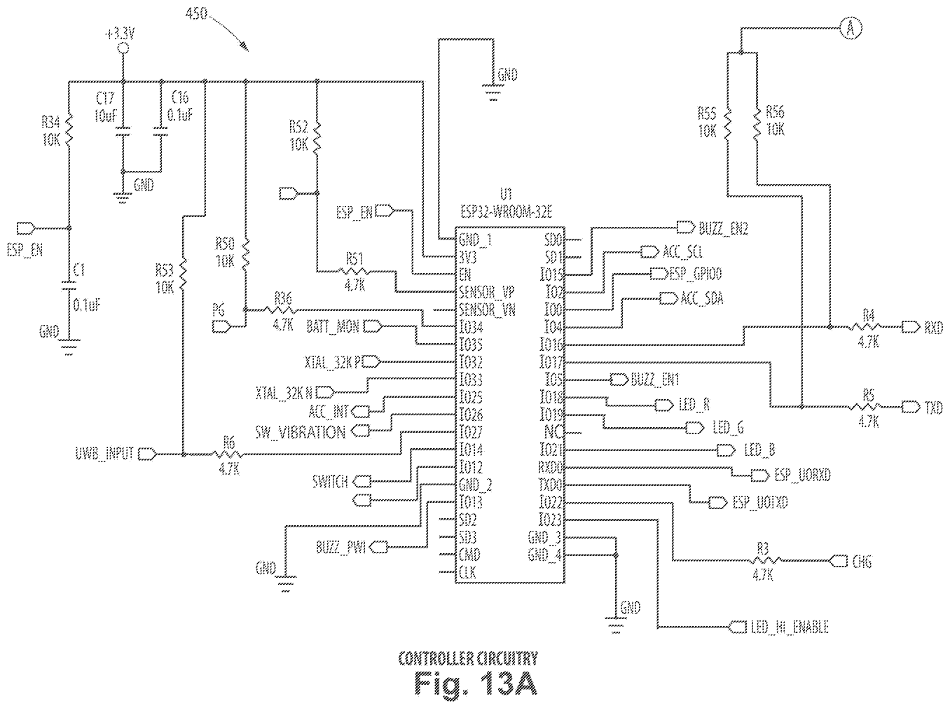

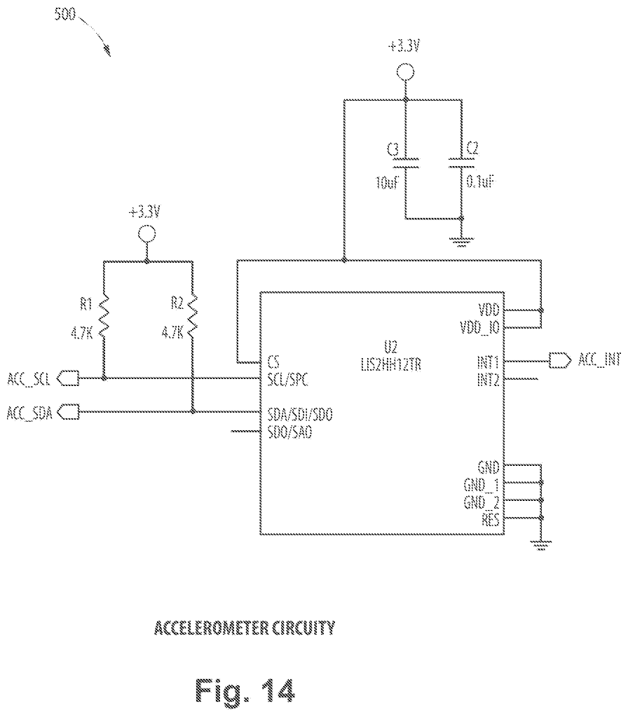

A function of the controller circuitry 450 is to activate one or more indicators or alarms to advise or warn the tool user wearing the beacon device 200 or personnel within range of the beacon device 200 that the tool 100 is no longer within communication range of the beacon device 200. For example, the controller circuitry 450, seen in FIGS. 13A and 13B, can supply a PWM signal (Buzz PWM) appropriate to drive the buzzer B1 or other output device at a desired frequency of the indicator generator circuitry 400, seen in FIGS. 12A and 12B. The one or more indicators or alarms can be, for example, a piezo buzzer B1, a vibration (haptic) motor M1, and/or one or more visual indicators, e.g., one or more LED's, such as LED1, LED2, LED3, LED4 and LED5. In the exemplary embodiment shown, the visual indicators are visible via one or more openings (not shown) in the rear housing portion 214. Such openings may have transparent windows. However, if the housing 210 is made of a translucent polymer material, the one or more visual indicators, e.g., LED1, LED2, LED3, LED4 and/or LED5, would be visible through the translucent polymer material. As noted, the beacon device 200 may also include the accelerometer circuitry 500, seen in FIG. 14, that works in conjunction with the controller circuitry 450 to detect when the beacon device 200 is stationary or moving.

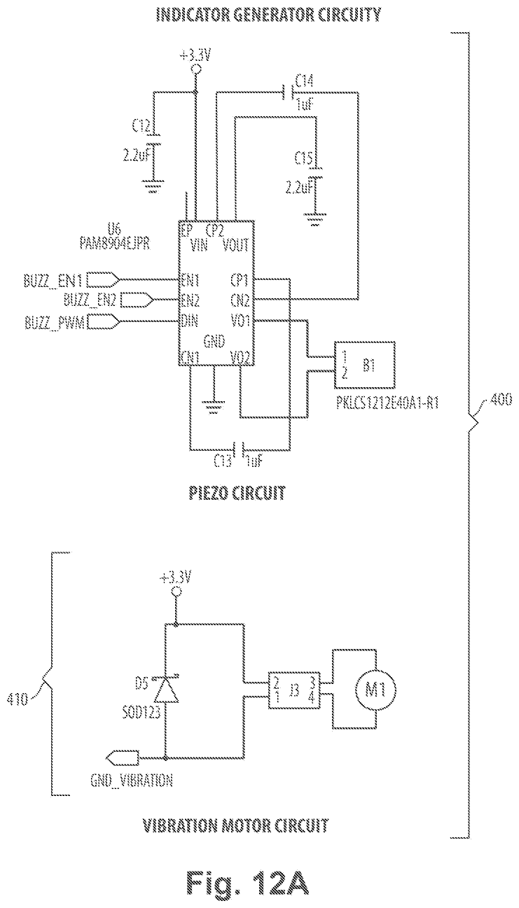

The beacon device 200 may also include one or more input device 226, such as a pushbutton switch, that can be used, for example, to quickly pair, assign or link a particular tool 100 to a particular beacon device 200. This pairing of tools 100 to beacon devices 200 permits tool managers to quickly and easily sign tools “in” and “out” without the need to get a particular user's smartphone and go through an App's interface. As an alternative, pairing may be a basically permanent condition allowing paired devices to automatically detect and connect to each other when in communication range. The one or more input devices 226, seen in FIGS. 1 and 10, may also be configured to switch or mute a particular indicator device, e.g., the haptic indicator M1, the audible indicator B1 or the visual indicator LED1-LED5 of the indicator generator circuitry 400.

If the beacon device 200 includes the accelerometer circuitry 500 and the one or more tools 100 paired to the beacon device 200 includes accelerometer circuitry 198, data from the accelerometer circuitry 500 and the accelerometer circuitry 198 can be used along with signal strength to optimize the rate of communication between the beacon device 200 and the one or more tools 100. It is noted that the accelerometer circuitry 198 is substantially similar to the accelerometer circuitry 500 shown in FIG. 14. For example, if a tool 100 and/or a beacon device 200 paired to the tool 100 has been at rest, or if the tool 100 and the paired beacon device 200 are within communication range for a predetermined period of time, then system information may not need to be uploaded by the tool 100 to the beacon device 200 frequently. This typically occurs when the one or more tools 100 and one or more beacon devices 200 are stored overnight. However, if the beacon device 200 determines the signal strength of a communication signal between the beacon device 200 and its paired tools 100 falls below a predetermined threshold, which is indicative that the tool 100, the beacon device 200 or both are moving, the beacon device 200 increases the rate of communication between the beacon device 200 and the tool 100 so that the beacon device 200 stores the most current location of the tool 100 before the tool 100 is no longer within the communication range with the beacon device 200. In other words, before the beacon device 200 loses contact with the tool 100, the beacon device 200 causes the tools 100 to upload its most current system information to the beacon device 200. This process could also be initiated by the tool 100. It is noted that the location sensor 123 in the tool 100 continuously determines the location of the tool 100 based on, for example, a radio frequency signals received from a global navigation system. As a result, that the most current or the latest possible location of the tool 100 determined by the location sensor 123 can be uploaded to the beacon device 200 before the tool 100 moves out of the communication range of the beacon device 200.

In one embodiment, the tools 100 and the beacon devices 200 may periodically perform an access point (AP) scan to determine if the tools 100 and/or the beacon devices 200 are in their home facility, which is the location where the tools 100 and/or the beacon devices 200 are stored when not in use. If, for example, the Wi-Fi service set identifier (SSID) of the home facility is detected, and the one or more tools 100 and/or the beacon devices 200 are paired with the home facility, then the one or more tools 100 and/or the beacon devices 200 will be connected to the home facility. For purposes of the present disclosure, a “connection” to a home facility SSID merely indicates detection of presence of the SSID, e.g., from an active or passive AP scan, and may not involve recognition by the access point device, or two-way exchange of data between the tool 100 or beacon device 200, and the access point device. However, a beacon device 200 or tool 100 may also connect as a station to the access point for purpose of Internet connectivity and communication with the cloud-based computing system 12. Each beacon device 200 and tool 100 may also broadcast one or more signals at regular intervals. Such broadcast signals may include the transmitting device's identity, cycle data, e.g., crimp data, and data concerning other connected beacon devices 200. Such broadcast signals are transmitted and intended to be received by all connected tools 100 or beacon devices 200 generally without direct acknowledgement. This technique allows multiple tools 100 and beacon devices 200 to be mutually connected, without generating excessive levels of RF traffic with risk of collisions and interference. Generally, each tool 100 and/or beacon device 200 can sleep except during its own broadcast signal transmission interval and that of any connected tool 100 and/or beacon device 200 followed by a short delay to allow for a handshaking process to connect to or disconnect from another device. This results in an energy savings and extension of battery life. However, if the home facility SSID or a paired beacon device 200 or tool 100 is not detected after a programmed time delay or number of broadcast signal transmission intervals, or if the beacon device or tool's accelerometer 198 indicates a moving state of the beacon device or tool, the beacon device 200 or tool 100 may wake for a period to scan for broadcast signal transmissions from paired tools 100 or beacon devices 200. If any paired tools 100 or beacon devices 200 are found, the tool 100 or beacon device 200 may initiate a handshake process to connect to the paired tool 100 or beacon device 200 and will record the transmission timing so the tool 100 or beacon device 200 can wake at the appropriate time to receive the broadcast signal transmission. Similarly, when the tool 100 or beacon device 200 is at a home facility, the tool 100 or beacon device 200 may initiate another handshaking request to disconnect from other connected tools 100 and/or beacon devices 200 in the home facility. In this way, connecting is automatic after the tools 100 and/or beacon devices 200 are paired. As a result, authorized personnel carrying the appropriate beacon device 200 may leave with a tool 100 without any special checkout process.

Another exemplary embodiment, the accelerometer circuitry 500 may be used to determine whether the tool user (i.e., the wearer of the beacon device 200) is moving (walking) or stationary. If stationary, the components, e.g., transceivers and processors, are allowed to sleep or power down, or extend wake intervals, to conserve power, and the beacon device 200 can periodically emit a beacon to its paired tools 100 using the Bluetooth Low Energy (BLE) transceiver or other known techniques. The beacon device 200 then delays a short time before returning to the sleep/idle state. With moving beacon devices 200, as identified by the accelerometer circuitry 500, the controller circuitry 450 and at least one transceiver are kept active, or may wake for an extended duration, or decrease wake intervals, to listen for beacons from the one or more tools 100 paired with the beacon device 200.

As noted above, the indicator generator circuitry 400, shown in FIGS. 12A and 12B, may include circuitry to drive visible, audible and/or haptic indicators in the beacon devices 200. In the exemplary embodiment shown, the beacon devices 200 may include a buzzer or speaker B1, seen in FIG. 12A, used to provide an audio warning or feedback that one or more paired tools 100 is no longer within the communication range of the beacon device 200. In such an example, the buzzer or speaker B1 may be a piezo device, and the indicator generator circuitry 400 may include a piezo driver circuit U6 that drives the piezo device. In addition, the beacon devices 200 may include a haptic device M1, seen in FIG. 12A, used to provide haptic warning or feedback to the tool user wearing the beacon device 200 that the tool 100 is no longer within the communication range of the beacon device 200. In such an example, the haptic device M1 may be a vibration motor, and the indicator generator circuitry 400 may include a vibration motor circuit 410 that in conjunction with the controller circuitry 450 drives the vibration motor M1. In the exemplary embodiment shown, the vibration motor M1 is mounted, e.g., via SMD soldering, adhesive or other means, to the printed circuit board 224 within housing 210 of the beacon devices 200. As an alternative, the vibration motor may be mounted to other components, for example the housing 210. The one or more visual indicators, which in this exemplary embodiment includes LED1-LED5, is also mounted to the printed circuit board 224 within housing 210 of the beacon devices 200. In another exemplary embodiment, the LEDs, e.g., LED1-LED5, can be controlled to represent different operational states or alarms. For example, only one LED may be illuminated or flashed, or two or more LEDs may be illuminated or flashed. Illuminating one LED may be indicative of the beacon device 200 being in an ordinary charge/operation state. Flashing all LEDs may be indicative of an alarm that one or more paired tools 100 are no longer within the communication range of the beacon device 200. The LEDs may have multiple elements such as multiple colors, e.g., RGB LEDs, and the overall color and intensity may be varied by PWM control of each LED element.

As shown throughout the drawings, like reference numerals designate like or corresponding parts. While illustrative embodiments of the present disclosure have been described and illustrated above, it should be understood that these are exemplary of the disclosure and are not to be considered as limiting. Additions, deletions, substitutions, and other modifications can be made without departing from the spirit or scope of the present disclosure. Accordingly, the present disclosure is not to be considered as limited by the foregoing description.

As described herein, the beacon devices 200 according to the present disclosure are capable of communicating with multiple tools 100 via, for example, Bluetooth or Wi-Fi technology to receive system information from the tools 100, such as a GPS location of the tools and/or crimp history associated with the tools 100. It is noted that the beacon devices 200 of the present disclosure contemplate using other RF technologies for communication, including sub-gigahertz technologies or radios. The beacon devices 200 may also be configured to connect to a mobile computing device 20 and upload system information to the mobile computing device 20 via a mobile app over Bluetooth.

On the work site, the beacon can give visual and auditory alerts when tools that have been assigned to it have moved out of its wireless range. This could occur when tools have been left behind, become damaged, or are stolen. This immediate feedback will greatly reduce the risk of tools being separated from their user.

As an added theft deterrent, the beacon device 200 may serve as a key, so that the one or more tools 100 paired with the beacon device 200 can only be operated when the one or more tools 100 are within the wireless communication range of the beacon device 200. A grace period, e.g., 24 hours, could be applied to avoid a nuisance to the operators. Additionally, the beacon device 200 may be configured to periodically establish a connection to the cloud computing system database 14 in order for the beacon device 200 to remain valid, in an effort to prevent a stolen beacon device 200 from continuing to allow one or more tools 100 paired to the stolen beacon device 200 to operate. Alternatively, the beacon device 200 may be configured to connect to a home facility periodically in order to remain valid.

As noted, the term “pairing” is used herein in its conventional sense, namely that there is a one-time association that needs to be performed by a user to link, for example, a specific tool 100 to a specific beacon device 200. When a tool 100 and a beacon device 200 are paired together, they exchange identification information, such as MAC address, ID name, etc. Once this pairing association has been performed, the associated tool 100 and beacon device 200 are “connected” to one another when the tool 100 and the beacon device 200 are within communication range. Connected devices generally refers to when two devices are in communication range and the devices can exchange periodic streams of data in the background between the paired devices that link them together and inform each device of the others status. By connecting one or more tools 100 with one or more beacon devices 200, so that these devices periodically communicate with each other wirelessly, if the beacon device 200 loses the communications link with one or more paired tools 100, then both the tool 100 and the beacon device 200 can perform certain actions, such as notifying nearby tool users via audible, haptic and/or visible alarm conditions or take on other predefined behavior.

In the exemplary embodiments described herein, once a tool 100 is paired with a beacon device 200, the allowed methods to unpair the tool 100 and the beacon device 200 is by connecting the tool 100 or the beacon device 200 with an App running on a mobile computing device 20, e.g., a smartphone, and removing the association from a pairing list in the App, or by signing into a device hosted web page via the cloud computing system 12 and removing the association from the pairing list of the tool 100 and/or the beacon device 200. The tool 100 and the beacon device 200 can be configured to allow a password to be set through the App or the device hosted web page to protect the pairing list. If a password is set, then the password is entered before pairing and/or unpair a tool 100 and a beacon device 200. The tool management system 10 can be configured to permit N-to-N pairing, where one tool 100 can be paired to multiple beacon devices 200 and/or one beacon device can be paired with multiple tools. Multiple methods of pairing may be used, and protection could be implemented as described herein to prevent unwanted pairings. A method of pairing a tool 100 to a beacon device 200 can be to automatically pair the tool 100 and the beacon device 200 if an input device 190 on the tool 100 and an input device 226 on the beacon device 200 are simultaneously activated when both devices are within communication range. Through the App or the device hosted web page, a Pairing PIN can be assigned to both the tools 100 and the beacon devices 200. If a Pairing PIN is assigned to both the tools 100 and the beacon devices 200, then the PINs have to match on both devices before the pairing is permitted. The Pairing PIN is not visible without knowing the password. In this configuration, the Pairing PINs can be used to prevent a stolen tool 100 from being able to be paired with a different beacon device 200. Optionally, multiple PINs could be assigned to the tools 100 and the beacon devices 200 for flexibility of user assignments so that different categories of tools 100 and different categories of users can be created.

As noted herein, the beacon devices 200 may be stationary devices that are fixed to a facility, fixed at a work site, or mounted to a work vehicle. The beacon devices 200 may also be portable or mobile devices that are intended to be worn on, for example, a workers toolbelt. One possible form factor may be that the beacon devices 200 are portable or mobile devices and that work trucks and facilities will contain mounted charging cradles that hold the beacon devices 200. When working near the truck, the beacon devices 200 could be left in the charging cradle but could be removed and worn in instances when a worker needs to work away from the work vehicle.

In operation, once one or more tools 100 are paired to one or more beacon devices 200, the one or more tools 100 and the one or more beacon devices 200 should regularly communicate when within the communication range of the devices, and if they lose communications for a predefined period of time, e.g., communication timeout period, both the one or more tools 100 and the one or more beacon devices 200 can notify nearby tool users with audible, haptic and/or visible alarms. In an alarm state, the App can be used to query a status of the communication connections between the one or more tool 100 and the one or more beacon devices 200 to generate a list of missing tools. If the one or more tools 100 and the one or more beacon devices 200 remain disconnected for a predetermined period of time, e.g., 12 hours or 24 hours, each disconnected tool 100 can be configured to enter an inoperable state until reconnected with a beacon device 200.

As noted herein, there may be instances where a tool 100 is paired to multiple beacon devices 200. Such an instance may occur when multiple workers each wearing a beacon device 200 are paired to the tool 100 at the work site, or in a work vehicle or at a facility. In such instances, the tool 100 would not enter alarm state unless it could not communicate with any of the paired beacon devices 200. Similarly, if a tool 100 is paired to two beacon devices 200, and the tool 100 is moved outside of the communication range of one beacon devices 200 such that the beacon device becomes disconnected, the disconnected beacon device 200 would activate an alarm condition, but the tool 100 would not activate an alarm condition since the tool is still connected to the other beacon device 200. Alternatively, the tool 100 could communicate, e.g., share addresses and identities of other connected devices, to all beacon devices 200 to which it is connected, and a beacon device 200 losing the connection may not activate an alarm if there were other connected beacon devices 200 in place with sufficient signal strength.

In instances where multiple tools 100 are paired with one beacon device 200, the beacon device 200 may be configured to activate an alarm condition if the beacon device 200 cannot connect to all of the paired tools 100, e.g., the beacon device 200 is not within communication range of all of the paired tools 100.

As noted above, the input devices 190 and 226 that may be used for pairing a tool 100 to a beacon device 200 may also be used as a timed mute of the activated alarm condition to help avoid nuisance alarms.

As described herein, connecting paired tools 100 and beacon devices 200 may be implemented using several different wireless technologies, with each technology having different capabilities for range and battery life. A lowest cost option may be to build the system around the controller circuitry 450, which in this embodiment includes an ESP32 module that contains both BLE and 802.11 radios. A BLE based system would likely have the longest battery life and lowest range, probably on the order of up to 300 feet maximum connection distance. An 802.11 based system would likely have on the order of about 500 foot to about 1000 feet maximum connection distance between the tool 100 and the beacon device 200 (i.e., the communication distance between the tool 100 and the beacon device 200) with a decrease in battery life. However, the maximum connection distance between the tool 100 and the beacon device 200 (communication distance between the tool 100 and the beacon device 200) may be increased by using a low data rate ‘LR’ protocol. The connection distance between the tool 100 and the beacon device 200 may be increased using alternative RF technologies, such as sub-gig radios or external antennas for facility and vehicle mounted beacon devices 200. In any case, the operative distance is greatly influenced by environmental surroundings such as buildings and vehicles which may block or reflect radio transmissions. It is also possible for multiple tools 100 or beacon devices 200 to form a mesh network to further extend the range.

If the tools 100 contain a location sensor 182, for example GPS module, then the location coordinates can be exchanged in the communication messages between the tool 100 and the beacon device 200. This would provide a method to retrieve the ‘last known location’ of a missing tool 100 by querying the beacon device 200 via the App.

It would be possible for tools 100 and the beacon devices 200 to scan for Wi-Fi access points and recognize when they have returned to their home facility for example by recognizing the home SSID. If desired, the tools 100 and/or the beacon devices 200 may be configured to initiate predefined operations when at the home facility such as disabling the communication link (disabling the connection) between the tools 100 and their paired beacon devices 200 to save battery life, or to clearing the pairings between the tools 100 and tier paired beacon devices 200 when returning to the home facility.

As shown throughout the drawings, like reference numerals designate like or corresponding parts. While exemplary embodiments of the present disclosure have been described and illustrated above, it should be understood that these are exemplary of the disclosure and are not to be considered as limiting. Additions, deletions, substitutions, and other modifications can be made without departing from the spirit of the present disclosure. Accordingly, the present disclosure is not to be considered as limiting by the foregoing description.

What is claimed is:

1. A tool monitoring system comprising:
at least one beacon device having communication circuitry for wireless communications; and
at least one tool configured to wirelessly communicate with the communication circuitry of the at least one beacon device, wherein when the at least one tool is in wireless communication with the at least one beacon device, the at least one tool is configured to upload system information to the at least one beacon device.

2. The tool monitoring system according to claim 1, further comprising a cloud-based computing system configured to wireless communicate with the at least one beacon device, wherein when the at least one beacon device is in communication with the cloud-based computing system, the cloud-based computing system can receive the system information from the at least one beacon device and store the system information in a database.

3. The tool monitoring system according to claim 1, wherein the system information includes tool information.

4. The tool monitoring system according to claim 1, wherein the system information includes cycle information.

5. The tool monitoring system according to claim 1, wherein when the at least one tool is not in wireless communication with the at least one beacon device for a predetermined period of time, the at least one tool is configured to enter an inoperable state.

6. The tool monitoring system according to claim 5, wherein the predetermined period of time is 12 hours or 24 hours.

7. The tool monitoring system according to claim 1, wherein the at least one tool comprises a frame and a working head.

8. The tool monitoring system according to claim 1, wherein the at least one beacon device includes at least one indicator used to provide at least one of an audible, haptic and visual indication when the at least one beacon device is no longer in communication with the at least one tool.

9. The tool monitoring system according to claim 1, wherein the at least one beacon device comprises a housing configured to be worn by a user or installed in a vehicle or installed in facility.

10. A beacon device comprising:
a housing having a front housing portion, a rear housing portion and at least one cavity for receiving internal components;
communication circuitry within the at least one cavity, the communication circuitry being configured to receive system information from at least one tool when the beacon device is in communication with the at least one tool and configured to upload the system information to a cloud-based computing system when the beacon device is in communication with the cloud-based computing system; and
at least one indicator used to provide at least one of an audible, haptic and visual indication when the beacon device is no longer in communication with the at least one tool.

11. The beacon device according to claim 10, wherein the housing of the beacon device is configured to be worn by a user or installed in a vehicle or installed in facility.

12. The beacon device according to claim 10, wherein the system information includes tool information.

13. The beacon device according to claim 10, wherein the system information includes cycle information.

14. The beacon device according to claim 10, wherein the system information includes tool information and cycle information.

15. A beacon device comprising:
a housing;
communication circuitry within the housing, the communication circuitry being configured to receive system information from at least one tool when the beacon device is in communication with the at least one tool; and
at least one indicator used to provide at least one of an audible, haptic and visual indication when the beacon device is no longer in communication with the at least one tool.

16. The beacon device according to claim 15, wherein the communication circuitry is configured to upload the system information received from the at least one tool to a cloud-based computing system when the beacon device is in communication with the cloud-based computing system.

17. The beacon device according to claim 15, wherein the housing of the beacon device is configured to be worn by a user or installed in a vehicle or installed in facility.

18. The beacon device according to claim 15, wherein the system information includes tool information.

19. The beacon device according to claim 15, wherein the system information includes cycle information.

20. The beacon device according to claim 15, wherein the system information includes tool information and cycle information.
